(19) United States
(12) Patent Application Publication
(10) Pub. No.: US 2026/0172348 A1
(43) Pub. Date: Jun. 18, 2026

(54) Multi-Homing Device Handling of Control Plane Messages during Anticipated Control Plane Downtime

(71) Applicant: Arista Networks, Inc., Santa Clara, CA (US)

(72) Inventors: Pavan Narasimhaprasad, Cedar Park, TX (US); Anand Narayanan, Austin, TX (US); Mason Alexander Flowers, Austin, TX (US); Akhil Shashidhar, Cedar Park, TX (US); Alton Lo, Fremont, CA (US)

(21) Appl. No.: 18/984,743

(22) Filed: Dec. 17, 2024

(51) Int. Cl. H04L 45/586; H04L 45/00; H04L 45/748

(52) U.S. Cl. CPC H04L 45/586; H04L 45/566; H04L 45/748

(57) ABSTRACT

A multi-homing network device may undergo an operation during which its control plane is inactive while its data plane remains active. During this operation, the data plane of the multi-homing network device may forward control plane messages to a peer multi-homing network device. The data plane of the peer multi-homing network device may receive and forward the control plane messages to the control plane of the peer multi-homing network device for appropriate processing.

### BACKGROUND

This relates to network devices, including network devices configured to operate in a multi-homing configuration.

For example, a set of network devices that multi-homes a host can operate as a singular virtual entity from the perspective of the host. Accordingly, some network traffic, such as control plane messages, from the host can be received by and processed at any of the network devices.

### BRIEF DESCRIPTION OF THE DRAWINGS

FIG. 1 is a diagram of an illustrative network having network devices in a multi-homing configuration in accordance with some embodiments.

FIG. 2 is a diagram of an illustrative network device in accordance with some embodiments.

FIG. 3 is a diagram of an illustrative multi-homing network device that experiences control plane downtime while its data plane remains active in accordance with some embodiments.

FIG. 4 is a diagram of illustrative multi-homing network devices configured to perform control plane traffic handling during control plane downtime at one of the multi-homing network devices in accordance with some embodiments.

FIG. 5 is a diagram of an illustrative multi-homing network device preparing for its control circuitry to be inactive in accordance with some embodiments.

FIG. 6 is a diagram of an illustrative multi-homing network device configured to handle control plane traffic from a peer multi-homing network device with inactive control circuitry in accordance with some embodiments.

FIG. 7 is a diagram of an illustrative encapsulated control plane message conveyed between peer multi-homing network devices in accordance with some embodiments.

FIG. 8 is a flowchart of illustrative operations for operating a network device experiencing control plane downtime while its data plane remains active in accordance with some embodiments.

FIG. 9 is a flowchart of illustrative operations for operating a network device when a peer network device experiences control plane downtime in accordance with some embodiments.

### DETAILED DESCRIPTION

A network can convey network traffic (e.g., in the form of frames, packets, and/or other formats) between hosts. To properly forward the network traffic, the network can include a number of network devices. In an illustrative configuration, a set of network devices may be configured to multi-home a host or another network device, or generally a network portion. In this multi-homing configuration, the multi-homing network devices can serve as a single virtual entity from the perspective of the multi-homed device. Accordingly, when the multi-homed device communicates with the single virtual entity, any of the multi-homing network devices may receive traffic from the multi-homed device and/or any of the multi-homing network devices may transmit traffic to the multi-homed device.

However, issues may arise when a given one of the multi-homing network devices experiences control plane downtime (e.g., as part of a planned control plane restart or update) during which its data plane is still functional. This can cause the given network device to mishandle control plane messages received from the multi-homed device.

To mitigate these issues, the given network device may configure, prior to its control plane being inactive, its data plane to perform forwarding (e.g., tunneling) of control plane messages (e.g., address resolution protocol (ARP) messages) to a peer multi-homing network device. Accordingly, after the control plane of the given network device is down, a control plane message received at the data plane of the given network device is forwarded to the peer multi-homing network device (instead of being forwarded to the local inactive control plane). The peer multi-homing network device may be configured to receive and process any control plane messages forwarded (e.g., tunneled) in this manner (e.g., from another peer-multihoming network device) using the control plane of the peer multi-homing network device (as if the peer multi-homing network device itself received the control plane message on its local interface connected to the multi-homed device). Illustrative details for the handling of control plane messages by multi-homing network devices when the control plane(s) of some multi-homing network device(s) become inactive (while their data plane(s) remain active) are further described herein.

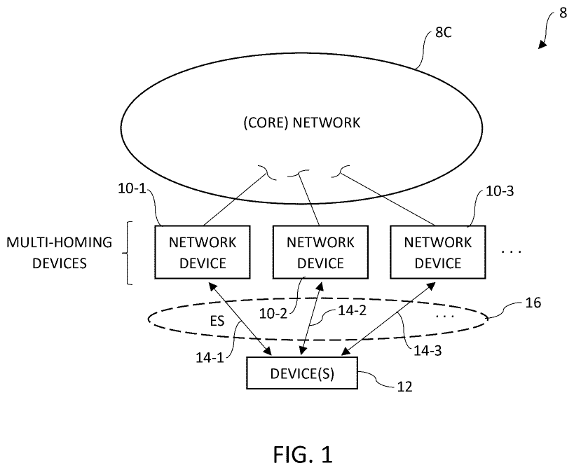

An illustrative network 8 that includes multi-homing network devices (e.g., configured to operate in the manner described above) is shown in FIG. 1. In particular, network 8 may be of any suitable scope and/or form part of a larger network of any suitable scope. As examples, network 8 may include, be, or form part of one or more local area networks, one or more data center networks, one or more campus area networks, one or more metropolitan area networks, one or more wide area networks, one or more cloud networks, etc. Network 8 may include any suitable number of different network devices that connect corresponding end hosts of network 8 to one another.

In general, network 8 may include one or more wired portions with network devices interconnected based on wired technologies or standards such as Ethernet (e.g., using copper cables and/or fiber optic cables) and, if desired, one or more wireless portions implemented by wireless network devices (e.g., to form wireless local area networks). If desired, network 8 may include internet service provider networks (e.g., the Internet) or other public service provider networks, private service provider networks (e.g., multiprotocol label switching (MPLS) networks), and/or may include other types of networks such as telecommunication service provider networks.

In the illustrative example of FIG. 1, network 8 may include a core network or core network portion 8C interconnecting different edge networks or edge network portions (e.g., different sites and/or different domains). As one illustrative example, core network portion 8C may include or form a backbone network such as one or more service provider networks (e.g., Internet or other Internet Protocol (IP) service provider networks, MPLS networks, cloud provider networks, etc.). Core network 8C (and the network devices therein) may provide and implement underlying infrastructure over which overlay virtual extensible local area network (VXLAN)-based and/or MPLS-based network(s) are implemented. Core network portion 8C may connect different edge network portions belonging to entities (e.g., customers) different from (or the same as) those that provide core network portion 8C.

Core network 8C may include core network devices which are sometimes referred to as provider (network) core devices whereas edge network devices, such as network devices 10-1, 10-2, and 10-3, may sometimes be referred to as provider (network) edge devices. The provider core devices may be interconnected with each other within core network portion 8C. Network paths may couple one or more provider core devices to provider edge devices (e.g., devices 10-1, 10-2, and 10-3) that serve as interfaces between core network 8C and the corresponding edge network portions. These edge network portions (e.g., each representing different site(s), domain(s), etc.) may each include its own set of hosts and its own set of network devices between its hosts and one or more corresponding provider edge devices.

Hosts of network 8 may be implemented on host equipment. Some hosts may be implemented on shared host equipment, while other hosts may each be implemented on a separate piece of host equipment. Host equipment (e.g., implementing hosts serving as end hosts of network 8 in an edge network portion or a site) may include computers, servers or server equipment, portable electronic devices such as cellular telephones, laptops, etc., network traffic storage devices, networking service devices, network management equipment that manages and controls the operation of one or more of hosts and/or network devices, and/or any other suitable types of specialized or general-purpose host computing equipment, e.g., running one or more client-side and/or server-side applications.

In the example of FIG. 1, network devices 10-1, 10-2, and 10-3 communicatively couple core network 8C to an edge network portion (e.g., a customer network portion) of network 8 containing device(s) 12 (e.g., network devices 12 and/or hosts 12). As examples, device(s) 12 of the edge network portion may be communicatively coupled to a provider edge device (e.g., device 10-1, 10-2, 10-3, etc.) indirectly via one or more intervening customer network devices or directly attached (e.g., via cable(s), without an intervening network device) to the provider edge device. Accordingly, intervening (customer) network device(s) may be communicatively coupled between device(s) 12 and each of network devices 10-1, 10-2, and 10-3. The intervening (customer) network device(s) may include (customer) network devices directly attached to provider edge devices and sometimes referred to as customer edge devices.

Network devices in network 8, such as (provider) core network devices in core network 8C, (provider) edge network devices (e.g., devices 10-1, 10-2, and 10-3), and (customer or site) network devices in the edge network portions, may each include or be a switch (e.g., a single-layer (e.g., layer 2) switch or a multi-layer (e.g., layer 2 and layer 3) switch), a bridge, a router, a gateway, a hub, a repeater, a firewall, a wireless access point, a network device serving other networking functions, a network device that includes the functionality of two or more of these devices, a management device that controls the operation of one or more of these network devices, and/or other types of network devices. Configurations in which network devices 10-1, 10-2, and 10-3 are (multi-layer) switches, routers, gateways, or network devices that generally include routing functionalities (e.g., implements routing protocols) are described herein as an illustrative example.

In some configurations described herein as an example, edge network devices 10-1, 10-2, and 10-3 may implement one or more Ethernet virtual private network (EVPN) instances over core network 8C, and accordingly, may be referred to as EVPN devices. In these illustrative configurations, the EVPN devices may exchange EVPN route information (e.g., hardware address reachability information) with one another over core network 8C. The EVPN route information may be exchanged based on any suitable underlying (transport layer and internet layer) protocol(s) that facilitate communication across core network 8C.

While network reachability information (e.g., hardware address reachability information, Ethernet segment reachability information, etc.) may be exchanged based on any suitable routing protocol, arrangements in which EVPN devices such as devices 10-1, 10-2, and 10-3 exchange network reachability information with one another using border gateway protocol (BGP), or more specifically multi-protocol BGP (MP-BGP), are described herein as an illustrative example. In these arrangements, devices 10-1, 10-2, and 10-3 may sometimes be referred to as BGP and/or EVPN speakers (e.g., configured to advertise and process corresponding advertised BGP messages containing EVPN route information). The use of BGP (e.g., MP-BGP) to implement the exchange of EVPN route information is merely illustrative. If desired, other routing protocols (or generally other control plane protocols) may be used to facilitate the exchange of EVPN route information between EVPN devices.

Still referring to FIG. 1, a set of (provider) edge network devices such as network devices 10-1, 10-2, and 10-3 may be configured in a network configuration that provides multi-homing for one or more devices 12 (e.g., host devices, customer or site edge network devices between the set of provider edge network devices and hosts, etc.). A multi-homed device 12 may have an interface (e.g., a port channel interface) coupled to a corresponding interface at network device 10-1, a corresponding interface at network device 10-2, and a corresponding interface at network device 10-3. These interfaces of the four network devices may be coupled via corresponding links (e.g., Ethernet link 14-1 between the Ethernet interfaces of devices 10-1 and 12, Ethernet link 14-2 between Ethernet interfaces of devices 10-2 and 12, and Ethernet link 14-3 between Ethernet interfaces of devices 10-3 and 12). Network devices 10-1, 10-2, and 10-3 may identify and configure links 14-1, 14-2, and 14-3 to collectively form an Ethernet segment 16, through which network traffic can be conveyed to and from the multihomed device 12 and any other network devices and hosts in the edge network portion behind device 12 (e.g., for which device 12 serves as the intervening device).

While three network devices 10-1, 10-2, and 10-3 are shown to multi-home device 12 and three links 14-1, 14-2, and 14-3 are shown to form Ethernet segment 16 in the example of FIG. 1, this is merely illustrative. If desired, any other suitable number of network devices (e.g., two network devices, more than three network devices, etc.) may multi-home device 12 and Ethernet segment 16 may include a corresponding Ethernet link for each of the network devices multi-homing device 12.

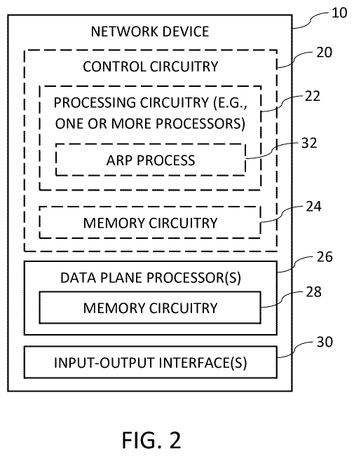

FIG. 2 is a diagram of an illustrative network device 10 (e.g., an illustrative multi-homing network device 10, different instances of which are usable to implement each of multi-homing network devices 10-1, 10-2, 10-3, etc., in FIG. 1). As shown in FIG. 2, network device 10 may include control circuitry 20 formed from processing circuitry 22 and memory circuitry 24, one or more data plane processors 26 (e.g., packet processor(s)), and input-output interfaces 30 mounted on and/or within a housing of network device 10. In one illustrative arrangement, network device 10 may be or form part of a modular network device system (e.g., a modular switch system having removably coupled modules usable to flexibly expand characteristics and capabilities of the modular switch system such as to increase the number of ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 22 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 22 may run (e.g., execute) a network device operating system and/or other software (including firmware) that is stored on memory circuitry 24. Memory circuitry 24 may include one or more non-transitory (tangible) computer-readable storage media that store the operating system software and/or any other software code, sometimes referred to as program instructions, software, data, instructions, or code. As an example, the control plane protocol operations performed by network device 10 described herein may be stored as (software) instructions on the one or more non-transitory computer-readable storage media (e.g., in portion(s) of memory circuitry 24). The corresponding processing circuitry (e.g., one or more processors of processing circuitry 22) may process or execute the respective instructions to perform the corresponding control plane protocol operations.

Memory circuitry 24 may include non-volatile memory (e.g., flash memory, electrically-programmable read-only memory, a solid-state drive, hard disk drive storage, etc.), volatile memory (e.g., static random-access memory or dynamic random-access memory), removable storage devices (e.g., storage devices removably coupled to device 10), and/or other types of memory circuitry. Processing circuitry 22 and (at least a portion of) memory circuitry 24 as described above may sometimes be referred to collectively as control circuitry 20 (e.g., implementing a control plane) for network device 10. Accordingly, processing circuitry 22 may sometimes be referred to as control plane processing circuitry 22 or control plane processor(s) 22.

As just a few examples, processing circuitry 22 may execute network device control plane software such as operating system software, routing policy management software, routing protocol or other protocol processes (e.g., an address resolution protocol (ARP) process, an EVPN process, a BGP process, etc.), routing information base processes, and other control software, may be used to support the operation of protocol clients and/or servers (e.g., to form some or all of a communications protocol stack), may be used to support the operation of data plane processor(s) 26, may store packet forwarding information, may execute packet processing software, and/or may execute other software instructions that control the functions of network device 10 and the other components therein.

Data plane processor(s) 26 (e.g., packet processor(s)) may be used to implement a data plane or forwarding plane of network device 10. Accordingly, data plane processor(s) 26 may sometimes be referred to as data plane processing circuitry 26. Data plane processor(s) 26 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

Data plane processor 26 may receive incoming network traffic via input-output interfaces 30, parse and analyze the network traffic, process the network traffic based on packet forwarding decision data (e.g., in a forwarding information base) and/or in accordance with network protocol(s) or other forwarding policy, and forward (or drop) the network traffic accordingly. The packet forwarding decision data may be stored on memory circuitry 28 (e.g., content-addressable memory) integrated as part of data plane processor 26, and/or if desired, separate from data plane processor 26. Memory circuitry 28 for data plane processor 26 may include volatile memory and/or non-volatile memory. The packet forwarding decision data may be stored a portion of memory circuitry 24, if desired.

Input-output interfaces 30 may include one or more different types of communication interfaces such as Ethernet interfaces, optical interfaces, network layer (e.g., Internet Protocol (IP) such as IPv4 and/or IPv6) interfaces, wireless interfaces such as wireless personal area network interfaces and wireless local area network interfaces, and/or other communication interfaces for connecting network device 10 to the Internet, local area networks, wide area networks, and/or generally other network device(s), peripheral devices, and computing equipment (e.g., host equipment such as server equipment, client devices, etc.). In illustrative configurations described herein as an example, input-output interfaces 30 may include Ethernet interfaces implemented using and therefore including (Ethernet) ports. In particular, data link layer interface circuitry may be coupled to the ports to form Ethernet interfaces with the desired interface configurations. Processing circuitry 22 may further form (e.g., configure) network layer interfaces (e.g., implemented over the Ethernet interfaces). The ports of network device 10 may be physically coupled and electrically connected to corresponding mating connectors of external equipment, when received at the ports, and may have different form-factors to accommodate different cables, different modules, different devices, or generally different external equipment.

The components of device 10 shown in FIG. 2 are merely illustrative. If desired, network device 10 may include other components such as power management circuitry, thermal management components (e.g., heatsinks, fans, etc.), etc. In general, the components of device 10 may be communicatively coupled to each other, or at least to processing circuitry 22 and/or memory circuitry 24 via corresponding signal paths. These signal paths may be configured to convey power (e.g., supply voltage(s)), control signals, data signals, and/or other information between the inter-coupled components of device 10.

Processing circuitry 22 may be configured to perform operations in accordance with one or more control plane protocols by executing one or more corresponding protocol processes (e.g., software instructions for the protocol processes). Control plane protocol processes, when executed by processing circuitry 22, may handle the generation, transmission, reception, and processing of control plane messages to implement operations specified by the control plane protocols. In some illustrative configurations sometimes described herein as an example, processing circuitry 22 may execute an address resolution protocol (ARP) process 32. ARP process 32, when executed by processing circuitry 22, may handle the generation, transmission, reception, and processing of ARP messages such as ARP request messages, ARP reply messages, ARP refresh messages, etc. In particular, the conveyance and processing of these types of messages may facilitate the discovery of bindings or mappings between data link layer addresses (e.g., Media Access Control (MAC) addresses) and network layer addresses (e.g., IP addresses) across devices in network 8.

In configurations in which network device 10 implements an EVPN with EVPN peer devices, processing circuitry 22 on network device 10 may execute an EVPN process. The EVPN process may manage and facilitate operations for implementing an EVPN such as the exchange of EVPN routes with other EVPN peer devices and the handling and processing of the exchanged information. If desired, the EVPN process may be implemented as part of a BGP process (e.g., performing operations in accordance with the border gateway protocol such as conveying EVPN route information in advertised BGP messages) executing on processing circuitry 22, or may be implemented separately from a BGP process that communicates with the EVPN process (e.g., both executing on processing circuitry 22).

While ARP process 32, an EVPN process, a BGP process, and/or other control plane protocol processes are sometimes described herein to perform parts of ARP, EVPN, BGP, and/or other control plane protocol operations for device 10, this is merely illustrative. Processing circuitry 22 may be organized in any suitable manner (e.g., to have other processes or agents instead of or in addition to ARP process 32, an EVPN process, a BGP process, and/or other control plane protocol processes, etc.) to perform different parts of the ARP, EVPN, BGP, and/or other control plane protocol operations described herein. Accordingly, processing circuitry 22 (or control circuitry 20 of device 10 formed therefrom) may sometimes be described herein to perform the ARP, EVPN, BGP, and/or other control plane protocol operations described herein instead of specifically referencing one or more agents, processes, and/or the kernel executed by processing circuitry 22 that performs these ARP, EVPN, BGP, and/or other control plane protocol operations.

A multi-homing network device 10 (e.g., one of devices 10-1, 10-2, or 10-3) may sometimes undergo a hitless restart operation or another operation during which the control plane of device 10 (e.g., control circuitry 20 of device 10) becomes inactive, while the data plane of the multi-homing network device 10 (e.g., data plane processor(s) 26, interface(s) 30, etc.) remains active. The hitless restart operation is intended to improve network operations by preserving data plane functionality while the control plane is inactive (e.g., being restarted as part of an update, as part of an operation to address a fault, etc.). However, given the multi-homing configuration, undergoing this type of operation can cause issues when the multi-homing network device 10 receives control plane messages while undergoing this type of operation. Configurations in which the control plane messages are address resolution protocol (ARP) messages are sometimes described herein as an example. If desired, the control plane messages may include messages for other types of control plane protocols.

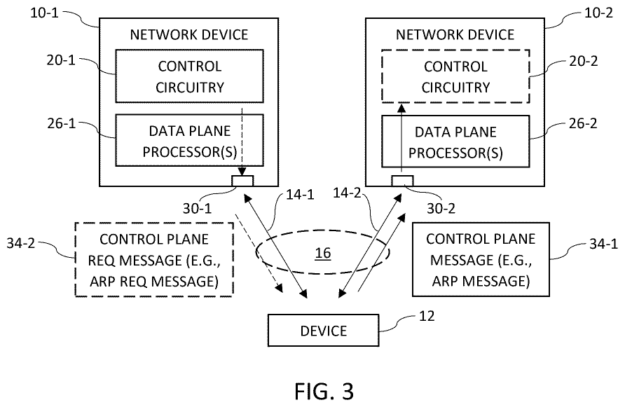

As one illustrative example, FIG. 3 shows a scenario in which network device 10-2 (FIG. 1) undergoes an operation during which control circuitry 20-2 (e.g., the control plane of device 10-2) is inactive while data plane processor(s) 26-2 (e.g., the data plane of device 10-2) remain active, to receive, process, and/or transmit network traffic via input-output interfaces such as interface 30-2. In particular, while control circuitry 20-2 is inactive, the multi-homed device 12 may transmit a control plane message 34-1 such as an ARP message, over link 14-2, to network device 10-2. Data plane processor(s) 26-2 may receive message 34-1 at interface 30-2 and (attempt to) forward the message to control circuitry 20-2 for processing. However, message 34-1 may not be appropriately processed due to control circuitry 20-2 being inactive. This can have adverse consequences to the operations of the control plane protocol.

As a first example in which message 34-1 is a request message (e.g., an ARP request addressed to the virtual MAC address shared by the multi-homing network devices 10-1, 10-2, 10-3, etc.), inactive control circuitry 20-2 may be unable to process the (ARP) request message. Accordingly, the appropriate (ARP) reply message (responsive to message 34-1) may not be generated by inactive control circuitry 20-2 and may not be transmitted by device 20-2 to multi-homed device 12. In the context of ARP, this can delay the discovery and/or updating of IP address to MAC address bindings by device 12, among other issues.

As a second example, message 34-1 may be a reply message (e.g., an ARP reply message addressed to the virtual MAC address shared by the multi-homing network devices 10-1, 10-2, 10-3, etc.) that is responding to a request message 34-2 (e.g., an ARP request message such as an ARP refresh message) transmitted by control circuitry 20-1 using data plane processor(s) 26-1 and interface 30-1, via link 14-1, to multi-homed device 12. Although request message 34-2 is sent from multi-homing network device 10-1, due to the multi-homing configuration, a different multi-homing network device such as device 10-2 with inactive control circuitry 20-2 may receive the corresponding (reply) message 34-1 (responsive to message 34-2) from device 12. Because inactive control circuitry 20-2 fails to appropriately process the (reply) message 34-1, this can lead to the ARP entry (e.g., an IP address to MAC address binding) identified by or otherwise associated with message 34-2 and maintained by the ARP process executing on control circuitry 20-1 to be deleted (e.g., via timeout) from memory circuitry of device 10-1 (e.g., memory circuitry 28 and/or 24 thereof) and subsequently from memory circuitry of each of the other multi-homing network devices 10-2, 10-3, etc.

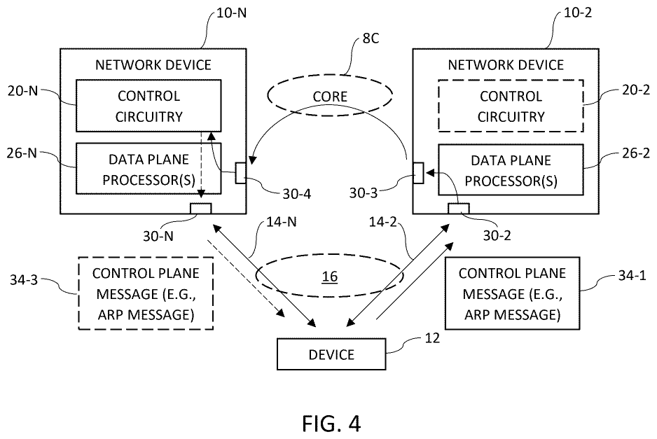

In order to mitigate these issues, an illustrative configuration of multi-homing network devices shown in the example of FIG. 4 may be implemented. As shown in FIG. 4, network device 10-2 with inactive control circuitry 20-2 may receive control plane message 34-1 in the manner described in connection with FIG. 3. However, instead of data plane processor(s) 26-2 forwarding message 34-1 to inactive control circuitry 20-2, data plane processor(s) 26-2 may be configured to forward (e.g., encapsulate and transmit an encapsulated version of) control plane message 34-1 received at interface 30-2 via interface 30-3 toward a peer multi-homing network device 10-N for processing. In illustrative configurations sometimes described herein as an example, message 34-1 may be encapsulated for transport across core network 8C to reach device 10-N.

Network device 10-N may be any of the peer multi-homing network devices connected to device 12 via a link 14 in the same Ethernet segment 16 (e.g., any of the peer multi-homing network devices that share the same virtual MAC address to which message 34-1 is addressed). More explicitly, network device 10-N may be device 10-1 in FIGS. 1 and 3, may be device 10-3 in FIG. 1, or may be another network device 10 that multi-homes device 12 on the same Ethernet segment 16.

Data plane processor(s) 26-N of device 10-N may receive message 34-1 (e.g., encapsulated within a transport encapsulation header) at interface 30-4 of device 10-N. Based on processing the encapsulated version of message 34-1, data plane processor(s) 26-N of device 10-N may forward message 34-1 to active control circuitry 20-N for processing. Control circuitry 20-N of network device 10-N may appropriately process control plane message 34-1 (e.g., in the same manner that control circuitry 20-2 would have processed message 34-1 had control circuitry 20-2 been active and received message 34-1).

As a first example in which message 34-1 is a request message (e.g., an ARP request addressed to the virtual MAC address shared by the multi-homing network devices 10-1, 10-2, 10-3, etc., including device 10-N), control circuitry 20-N may generate the (ARP) reply message 34-3 (responsive to request message 34-1) and transmit message 34-3 using data plane processor(s) 26-N and interface 30-N, via link 14-N, to device 12. In such a manner, in the context of ARP, device 12 may discover and/or update the IP address to MAC address binding (e.g., indicated by message 34-3).

As a second example, message 34-1 may be a reply message (e.g., an ARP reply message addressed to the virtual MAC address shared by the multi-homing network devices 10-1, 10-2, 10-3, etc., including device 10-N) that is responding to a request message 34-2 (FIG. 3) transmitted by control circuitry 20-1 using data plane processor(s) 26-1 and interface 30-1, via link 14-1, to multi-homed device 12. In scenarios in which (reply) message 34-1 identifies an ARP entry (e.g., an IP address to MAC address binding) that is dynamically maintained by device 10-N (e.g., device 10-N is the sender of request message 34-2, is device 10-1 from the example of FIG. 3, etc.), the ARP entry may be refreshed by control circuitry 20-N and maintained on memory circuitry of device 10-N (e.g., memory circuitry 28 and/or 24 thereof), based on control circuitry 20-N receiving and processing message 34-1. In scenarios in which (reply) message 34-1 identifies an ARP entry that is statically stored on device 10-N (e.g., is dynamically maintained by a peer network device of device 10-N from which this static ARP entry is derived), control circuitry 20-N may, based on control circuitry 20-N receiving and processing message 34-1, update the local static ARP entry to be a dynamic ARP entry maintained on memory circuitry of device 10-N (e.g., memory circuitry 28 and/or 24 thereof) and may advertise (e.g., as a non-proxy EVPN (MAC-IP advertisement) route in a BGP message) the IP address and MAC address in the ARP entry to other EVPN devices, including its peer multi-homing devices (e.g., devices 10-1, 10-2, 10-3, etc.), thereby taking ownership of the ARP entry.

Configured in the manner described in connection with FIG. 4, a set of multi-homing network devices 10 communicatively coupled to a multi-homed device 12 over links 14 in the same Ethernet segment 16 can appropriately handle control plane messages (e.g., message 34-1) even when one of the multi-homing network devices (e.g., device 10-2) undergoes a hitless restart operation (or another operation during which its control circuitry is inactive while its data plane processors are active).

While FIGS. 3 and 4 show how a multi-homing network device (e.g., device 10-N) handles forwarded control plane messages from a single peer multi-homing device (e.g., device 10-2) operating with inactive control circuitry and with active data plane processors, this is merely illustrative. If desired, analogous forwarding operations may be employed when multiple multi-homing devices (for the same Ethernet segment) operate with inactive control circuitry and with active data plane processors, insofar as at least one of the multi-homing devices for the Ethernet segment operates with active control circuitry. As an example described in connection with FIG. 1, when both devices 10-2 and 10-3 operate with inactive control circuitry and active data plane processors, control plane message addressed to the virtual MAC address shared by devices 10-1, 10-2, and 10-3, when received at both devices 10-2 and 10-3 may be forwarded (e.g., with additional encapsulation) to device 10-1 (operating with active control circuitry). If desired, when both devices 10-2 and 10-3 operate with inactive control circuitry and active data plane processors, control plane messages addressed to the virtual MAC address shared by devices 10-1, 10-2, and 10-3, when received at device 10-2, may be forwarded (e.g., with additional encapsulation) to device 10-3 and subsequently to device 10-1 (operating with active control circuitry).

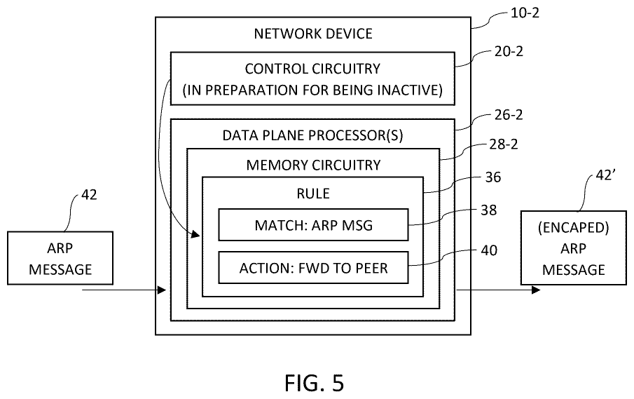

In order to facilitate the operations described in connection with FIG. 4, a multi-homing network device (e.g., device 10-2) may be configured to perform certain operations in anticipation of control plane downtime (e.g., when being expected to undergo hitless restart). FIG. 5 is a diagram of an illustrative multi-homing network device, such as device 10-2 (e.g., the device 10-2 in FIGS. 1, 3, and 4), configured to perform certain operations prior to control plane downtime (e.g., in preparation for control plane downtime).

As shown in FIG. 5, in preparation for control circuitry 20-2 being inactive in the future and while control circuitry 20-2 is still active, control circuitry 20-2 may generate and store (e.g., program, install, etc.) a traffic processing rule 36 on memory circuitry 28-2 for data plane processor(s) 26-2 to forward (e.g., by encapsulating for transport, by tunneling, by relay, etc.) ARP messages, which are addressed to the virtual MAC address shared by all of the multi-homing network devices 10 and would otherwise be sent to control circuitry 20-2, to a selected peer multi-homing network device (e.g., device 10-N in FIG. 4).

As an example, once rule 36 is generated and stored on memory circuitry 28-2, data plane processor(s) 26-2 of device 10-2 may receive (e.g., via interface 30-2 of device 10-2 from device 12 over link 14-2 in FIG. 4) an ARP message 42 (e.g., an ARP request message, an ARP reply message, as an example of message 34-1 in FIG. 4, etc.). Based on determining that message 42 matches on rule 36 (e.g., satisfies match criteria 38), data plane processor(s) 26-2 may perform action 40 based on received ARP message 42 to forward ARP message 42 toward a peer multi-homing device. In some illustrative configurations described herein as an example, data plane processor(s) 26-2 may transmit ARP message 42 with additional information (e.g., as an encapsulated version of ARP message 42′) toward the peer multi-homing device (e.g., toward device 10-N via interface 30-3 over core network 8C in FIG. 4).

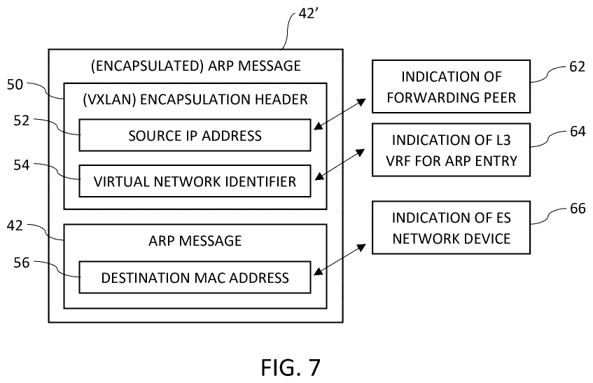

In particular, in the illustrative context of forwarding matching ARP messages, rule 36 may include one or more match criteria 38 that are satisfied when the network traffic being processed (e.g., compared for match) is an ARP message. As an example, a criterion 38 may specify an EtherType value (e.g., a value indicative of an ARP message, a hexadecimal value of 0×0806, etc.) for comparing to the value of the EtherType field in the network traffic to determine whether there is a match. If desired, an additional criterion 38 may specify a virtual MAC address value for comparing to the destination MAC address value of the network traffic to determine whether there is a match. Rule 36 may also include one or more actions 40 to be performed on network traffic (e.g., ARP messages) that satisfies match criteria 38 (e.g., when there is a match between the network traffic and match criteria 38). As an example, action 40 may specify that the matching ARP message be encapsulated with additional header information for transport to the selected peer multi-homing network device (e.g., device 10-N). An illustrative encapsulation for the ARP message (e.g., an encapsulated version of ARP message 42′) is further detailed in connection with FIG. 7.

While, in illustrative examples described in connection with FIGS. 1-4, a single Ethernet segment instance 16 is shown and described, this is merely illustrative. Each of multi-homing network devices 10 (e.g., device 10-1, 10-2, 10-3, etc.) may additionally be configured with additional Ethernet segment instances formed from corresponding links coupled to other multi-homed devices. As such, the operations described in connection with FIG. 4 for handling control plane traffic conveyed across links 14 for Ethernet segment 16 may similarly be performed for other Ethernet segments (e.g., for control plane messages received from other multi-homed devices on these other Ethernet segments). Accordingly, a different control plane message forwarding rule 36 of FIG. 5 may be generated and stored on memory circuitry 28-2 for each Ethernet segment instance configured on network device 10-2.

The control plane message forwarding rule(s) 36 of FIG. 5 may be generated and stored on memory circuitry 28-2 by control circuitry 20-2 as part of the shutdown procedure of control circuitry 20-2 (e.g., for performing and/or as part of initializing the hitless restart operation), or may be performed at another time prior to the anticipated control circuitry downtime. Accordingly, even when control circuitry 20-2 is still active (e.g., at partly operational), data plane processor(s) 26-2 may already begin forwarding, e.g., based on rule(s) 36, corresponding control plane messages (e.g., ARP messages) to the control circuitry of peer multi-homing network devices(s) (e.g., device 10-N in FIG. 4) for appropriate handling.

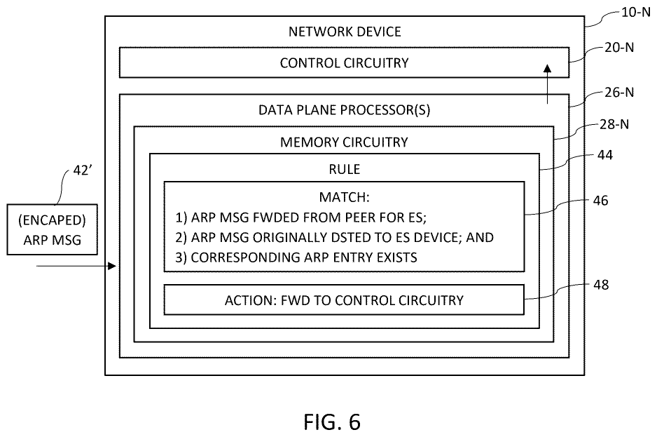

FIG. 6 is a diagram of an illustrative peer multi-homing network device, such as device 10-N (e.g., the device 10-N in FIG. 4), configured to handle forwarded control plane messages from another multi-homing network device (configured with the same Ethernet segment 16) having an inactive control plane. In the example of FIG. 6, control circuitry 20-N of device 10-N may generate and store, on memory circuitry 28-N for data plane processor(s) 26-N, a traffic processing rule 44 for processing forwarded control plane messages from another multi-homing network device having an inactive control plane (e.g., device 10-2). As shown in FIG. 6, an illustrative ARP message 42′ may be one such control plane message received by data plane processor(s) 26-N (e.g., via interface 30-4 over core network 8C from device 10-2 in FIG. 4). Rule 44 may include match criteria 46 and action 48 to be performed for network traffic matching on rule 44 (e.g., satisfying match criteria 46). In particular, matching network traffic such as ARP message 42′ may be forwarded, based on rule 44, by data plane processor(s) 26-N to control circuitry 20-N.

In particular, in the illustrative context of processing forwarded ARP messages, match criteria 46 may include a first criterion that is satisfied when the received message is an ARP message forwarded from a peer multi-homing device that is on (e.g., shares) the same Ethernet segment 16, may include a second criterion that is satisfied when the received message includes an original ARP message (sent by device 12) that is destined to an Ethernet segment device (e.g., addressed to the virtual MAC address shared by the multi-homing devices 10 of Ethernet segment 16), and may include a third criterion that is satisfied when the received message includes an original ARP message for which a corresponding ARP entry is locally stored on device 10-N (e.g., on memory circuitry 28-N and/or memory circuitry 24 of control circuitry 20-N). Action 48 may specify that the ARP messages satisfying criteria 46 and therefore matching on rule 44 be forwarded by data plane processor(s) 26-N to local control circuitry 20-N.

The three match criteria 46 shown and described in connection with FIG. 6 are merely illustrative. If desired, other criteria may be used instead of or in addition to criteria 46 as described above and/or one or more of match criteria 46 may be omitted. Accordingly, if desired, based on determining that received message 42′ is an ARP message (e.g., contains ARP message 42), data plane processor(s) 26-N may forward the received message 42′ to control circuitry 20-N and control circuitry 20-N may determine whether or not criteria 46 is satisfied as part of its processing of ARP message 42′. In other words, data plane processor(s) 26-N and/or control circuitry 20-N may determine whether or not ARP message 42′ satisfies criteria 46.

FIG. 7 is a diagram of an illustrative version of the ARP message transmitted by network device 10-2 described in connection with FIG. 5 and received by network device 10-N described in connection with FIG. 6. In the example of FIG. 7, ARP message 42′ is an encapsulated version of ARP message 42.

As shown in FIG. 7, encapsulated ARP message 42′ may include additional header fields of encapsulation header 50, and corresponding values therein, added by data plane processor(s) 26-2 of network device 10-2 in FIG. 5, e.g., based on one or more actions 40 (FIG. 5) being performed for ARP message 42 matching rule 36. In other words, actions 40 in FIG. 5 may include action(s) to add encapsulation header 50 (e.g., the fields and corresponding values therein). The added encapsulation header 50 and the values therein may be examined, when received as part of message 42', by data plane processor(s) 26-N of network device 10-2 in FIG. 6 to determine whether or not match criteria 46 of rule 44 are satisfied. In particular, the information conveyed in encapsulation header 50 may contain or otherwise indicate (e.g., map to) the same information as if ARP message 42 were directly received by device 10-N from multi-homed device 12, instead of via device 10-2 as encapsulated ARP message 42′. In such a manner, network device 10-N, which indirectly receives ARP message 42 (e.g., as part of message 42′) from multi-homed device 12, can still appropriately process ARP message 42.

In the example of FIG. 7, the added encapsulation header 50 may be an VXLAN encapsulation header including at least a source IP address field 52 and a virtual network identifier (VNI) field 54, while the original ARP message 42 being encapsulated may include at least a destination MAC address field 56.

Source IP address field 52 may contain the IP address of source of the encapsulated ARP message 42′, which is the IP address of device 10-2 in this example. Accordingly, the IP address of source of the encapsulated ARP message 42′ identified in field 52 may serve as an indication 62 of the forwarding peer multi-homing device (e.g., having the inactive control circuitry) and may be used by data plane processor(s) 26-N to determine whether the first criterion of criteria 46 in rule 44 is satisfied.

The inner destination MAC address field of ARP message 42′ may contain the destination MAC address of ARP message 42, when originally sent by multi-homed device 12. The destination MAC address of ARP message 42 may be the virtual MAC address shared by all of the multi-homing network devices 10 on Ethernet segment 16. Accordingly, destination MAC address identified in field 56 of ARP message 42 may serve as an indication 66 of an Ethernet segment network device being addressed (e.g., using the virtual MAC address which addresses any, and all, of the multi-homing network devices 10 on Ethernet segment 16) and may be used by data plane processor(s) 26-N to determine whether the second criterion of criteria 46 in rule 44 is satisfied.

Virtual network identifier field 54 may contain a virtual network identifier corresponding to the ingress VLAN of the original ARP message 42 as it was received by network device 10-2, which is the ingress VLAN of interface 30-2 in device 10-2, connecting to device 12 via link 14-2, in this example. Accordingly, the virtual network identifier corresponding to the ingress VLAN of the original ARP message 42 may serve as an indication 64 of the corresponding network layer (L3) virtual routing and forwarding instance for which the corresponding ARP entry indicated by ARP message 42 should be stored, and consequently, may be used by data plane processor(s) 26-N to determine whether the third criterion of criteria 46 in rule 44 is satisfied.

While the example of FIG. 7 illustrates how a VXLAN encapsulation header may be used for transport of ARP message 42 (e.g., from device 10-2, across network 8C, to device 10-N, etc.) and for conveying information based on which rule 44 can be applied by data plane processor(s) 26-N, this example is merely illustrative. If desired, other information (e.g., other types of encapsulation headers, other types of transport encapsulation header, etc.) may be added by device 10-2 when forwarding ARP message 42 to device 10-N.

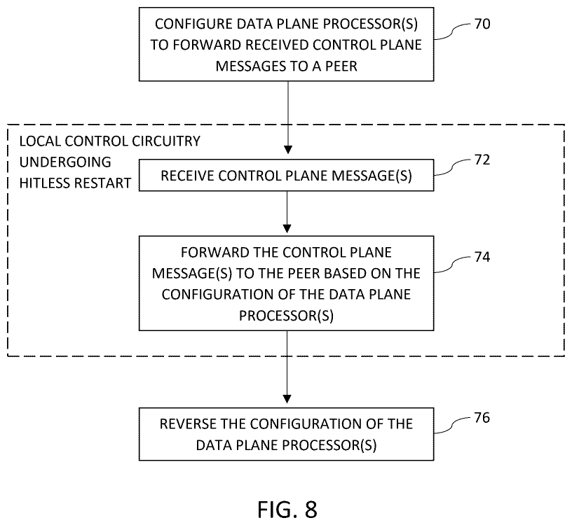

FIG. 8 is a flowchart of illustrative operations performed by a multi-homing network device configured to perform hitless restart. Some illustrative operations described in connection with FIG. 8 may be performed by one or more processors (e.g., processing circuitry 22 in FIG. 2) of one of multi-homing network devices 10-1, 10-2, 10-3, 10-N, etc., by executing software instructions stored on corresponding memory circuitry 24 (e.g., one or more non-transitory computer-readable media). Some illustrative operations described in connection with FIG. 8 may be performed by other dedicated hardware components (e.g., data plane processor(s) 26) in the same multi-homing network device.

At block 70, control circuitry (e.g., one or more control plane processors) of a multi-homing network device may configure its data plane processors to forward received control plane messages to a selected peer multi-homing network device (e.g., configured with the same Ethernet segment and sharing the same virtual MAC address for the Ethernet segment). This configuration can involve the generation and storage (e.g., the installation, programming, etc.) of a traffic processing rule on memory circuitry of the data plane processor(s). The operations at block 70 may be performed and completed prior to the control circuitry undergoing hitless restart (e.g., as part of the shutdown procedure in preparation for hitless restart), or otherwise being inactive while its data plane processor(s) remain active and operational. As an example, the operations performed at block 70 may include one or more operations performed by device 10-2 as described in connection with FIG. 5.

After the operations at block 70, the local control circuitry of the multi-homing network device may undergo hitless restart, during which the operations at blocks 72 and 74 may be performed. At block 72, the data plane processor(s) of the multi-homing network device may receive control plane message(s) such as ARP message(s) while the local control circuitry is undergoing hitless restart. At block 74, the data plane processor(s) of the multi-homing network device may forward the received control plane messages to the selected peer multi-homing network device based on the configuration of the data plane processor(s) by the local control circuitry (at block 70). In some illustrative configurations described herein, the received control plane messages may be modified (e.g., encapsulated) to include additional information when being forwarded to the selected peer multi-homing network device (based on the configuration of the data plane processor(s). As an example, the operations performed at block 72 and 74 may include one or more operations performed by device 10-2 as described in connection with FIGS. 4 and 5.

After undergoing hitless restart, at block 76, the local control circuitry of the multi-homing network device may reverse the configuration of the data plane processor(s) such that the control plane messages received at the data plane processor(s) will again be forwarded to the local (now active) control circuitry, instead of being forwarded toward the selected peer multi-homing network device. This reversing of the data plane processor configuration may include removing, deleting, or otherwise disabling the traffic processing rule (e.g., rule 46) programmed at block 70.

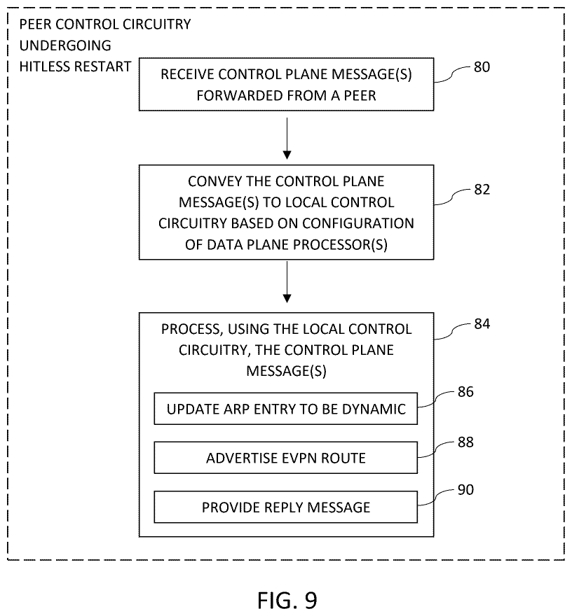

FIG. 9 is a flowchart of illustrative operations performed by a multi-homing network device whose peer multi-homing network device is undergoing hitless restart. Some illustrative operations described in connection with FIG. 9 may be performed by one or more processors (e.g., processing circuitry 22 in FIG. 2) of one of multi-homing network devices 10-1, 10-2, 10-3, 10-N, etc., by executing software instructions stored on corresponding memory circuitry 24 (e.g., one or more non-transitory computer-readable media). Some illustrative operations described in connection with FIG. 9 may be performed by other dedicated hardware components (e.g., data plane processor(s) 26) in the same multi-homing network device.

In general, the operations described in connection with FIG. 9 may be performed while a peer multi-homing network device, operating with the multi-homing device performing these operations of FIG. 9, is undergoing hitless restart (e.g., the same (peer) multi-homing network device performing the operations of blocks 72 and 74 in FIG. 8 while undergoing hitless restart).

At block 80, data plane processor(s) of a multi-homing network device may receive control plane message(s), such as ARP message(s), forwarded from the peer multi-homing network device undergoing hitless restart (e.g., forwarded as part of the operations at block 74 of FIG. 8). At block 82, the data plane processor(s) of the multi-homing network device may convey (e.g., forward) the received control plane message(s) to the local control circuitry of the multi-homing network device based on the configuration of the data plane processor(s). As an example, the operations performed at block 80 and 82 may include one or more operations performed by device 10-N as described in connection with FIG. 6.

At block 84, the local control circuitry of the multi-homing network device may process the received control plane message(s). As an example, the operations performed at block 84 may include one or more operations performed by device 10-N as described in connection with FIGS. 4 and 6.

In particular, as one example described in connection with FIG. 4, the received control plane message may be an (ARP) reply message addressed to the virtual MAC address shared by the multi-homing network device and its peer. In a first scenario of this example in which the reply message identifies an ARP entry that is statically stored on memory circuitry of the local control circuitry (e.g., is dynamically maintained by a peer from which this static ARP entry is derived), the local control circuitry may, based on receiving and processing the reply message, update the local static ARP entry to be a dynamic ARP entry maintained on memory circuitry of the local control circuitry (at block 86 of block 84) and may advertise a non-proxy EVPN (MAC-IP advertisement) route (e.g., in a BGP message) containing the IP address and MAC address in the ARP entry (at block 88 of block 84), thereby taking over ownership of the ARP entry. In a second scenario of this example in which the reply message identifies an ARP entry (e.g., an IP address to MAC address binding) that is dynamically maintained by the local control circuitry, the ARP entry may be refreshed and maintained on memory circuitry of the local control circuitry based on receiving and processing the reply message, thereby reaffirming ownership of the ARP entry.

In particular, as another example described in connection with FIG. 4, the received control plane message may be an (ARP) request message addressed to the virtual MAC address shared by the multi-homing network device and its peer. In this example, the local control circuitry of the multi-homing network device, at block 90 of block 84, may provide an (ARP) reply message that is responsive to the request message to the same multi-homed device (e.g., device 12), based on receiving and processing the request message.

The methods and operations described above in connection with FIGS. 1-9 may be performed by the components of one or more network devices and/or server or other host equipment using software (including firmware) and/or hardware (e.g., dedicated circuitry or hardware). Software code for performing these operations may be stored on one or more non-transitory computer-readable storage media (e.g., tangible computer-readable storage media) stored on one or more of the components of the network device(s) and/or server or other host equipment. The software code may sometimes be referred to as software, data, instructions, program instructions, or code. The one or more non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device(s) and/or server or other host equipment (e.g., by respective processing circuitry 22 of network devices 10-1, 10-2, 10-3, 10-N, etc., in FIGS. 1-9).

The foregoing is merely illustrative and various modifications can be made to the described embodiments. The foregoing embodiments may be implemented individually or in any combination.

What is claimed is:

1. A network device operable with a peer network device to multi-home a device, the network device comprising:
a data plane processor; and
control circuitry coupled to the data plane processor and configured to:
perform a hitless restart during which the control circuitry is inactive; and
store, prior to the control circuitry being inactive, a traffic processing rule for the data plane processor to forward control plane messages, matching on the traffic processing rule, to the peer network device.

2. The network device defined in claim 1, wherein the control plane messages comprise address resolution protocol (ARP) messages.

3. The network device defined in claim 2, wherein the data plane processor is configured to forward, when the control circuitry is inactive, a given ARP message matching on the traffic processing rule to the peer network device, wherein the forwarded version of the given ARP message includes an indication of the peer network device, an indication of a network layer virtual routing and forwarding instance for an ARP entry corresponding to the given ARP message, and an indication of the given ARP message being addressed to a virtual Media Access Control (MAC) address shared by the network device and the peer network device.

4. The network device defined in claim 3, wherein the forwarded version of the given ARP message is an encapsulated version of the given ARP message and contains an encapsulation header encapsulated by the data plane processor based on the traffic processing rule.

5. The network device defined in claim 4, wherein the indication of the peer network device is included in a source Internet Protocol (IP) address field of the encapsulation header, wherein the indication of the network layer virtual routing and forwarding instance is included in a virtual network identifier field of the encapsulation header, and wherein the virtual MAC address is included in a destination MAC address field of the given ARP message.

6. The network device defined in claim 4, wherein the encapsulation header is a transport header for conveying the given ARP message to the peer network device via a core network.

7. The network device defined in claim 1, wherein the control circuitry is configured to store the traffic processing rule as part of a shutdown procedure for performing the hitless restart.

8. The network device defined in claim 1, wherein the control circuitry is configured to delete the traffic processing rule after completing the hitless restart and becoming active.

9. A network device operable with a peer network device to multi-home a device, the network device comprising:
a data plane processor;
memory circuitry for the data plane processor; and
control circuitry coupled to the data plane processor and the memory circuitry, wherein the data plane processor is configured to:
receive a control plane message originating from the multi-homed device and forwarded via the peer network device to the network device; and
based on the control plane message matching on a traffic processing rule stored on the memory circuitry, provide the control plane message to the control circuitry for processing.

10. The network device defined in claim 9, wherein the peer network device is a network device configured to undergo hitless restart.

11. The network device defined in claim 9, wherein the control plane message is an address resolution protocol (ARP) message.

12. The network device defined in claim 11, wherein the ARP message indicates the peer network device as a forwarding device, indicates a corresponding ARP entry stored on the memory circuitry, and indicates an address shared by the network device and the peer network device.

13. The network device defined in claim 12, wherein the ARP message contains an encapsulation header with a first field that indicates the peer network device as the forwarding device and a second field that is usable to indicate the corresponding ARP entry stored on the memory circuitry and wherein the ARP message includes an inner destination MAC address that indicates the address shared by the network device and the peer network device.

14. The network device defined in claim 11, wherein the ARP message is an ARP reply message and wherein the control circuitry is configured to process the ARP reply message by updating a static ARP entry corresponding to the ARP reply message to be a dynamic ARP entry and advertising a non-proxy route associated with the dynamic ARP entry.

15. The network device defined in claim 11, wherein the ARP message is an ARP reply message and wherein the control circuitry is configured to process the ARP reply message by identifying a locally stored dynamic ARP entry and refreshing the dynamic ARP entry.

16. The network device defined in claim 11, wherein the ARP message is an ARP request message and wherein the control circuitry is configured to process the ARP request message by generating an ARP reply message responsive to the ARP request message and transmitting the ARP reply message to the multi-homed device.

17. The network device defined in claim 9, wherein the network device is operable with an additional peer network device to multi-home the device, wherein the additional peer network device is configured to undergo hitless restart, and wherein the data plane processor is configured to receive an additional control plane message originating from the multi-homed device and forwarded via the additional peer network device to the network device.

18. A network device operable with a peer network device to multi-home a device, the network device comprising:
a data plane processor; and
control circuitry coupled to the data plane processor and configured to:
perform an operation during which the control circuitry is inactive and the data plane processor is active; and
configure, prior to the control circuitry being inactive, the data plane processor to forward address resolution protocol (ARP) messages, addressed to an address shared by the network device and the peer network device, to the peer network device.

19. The network device defined in claim 18, wherein the data plane processor is configured to forward, when the control circuitry is inactive, a given ARP message addressed to the shared address by encapsulating the given ARP message with an encapsulation header.

20. The network device defined in claim 19, wherein the encapsulation header is a virtual extensible local area network (VXLAN) encapsulation header.
